(19) United States
(12) Patent Application Publication
(10) Pub. No.: US 2017/0351778 A1
(43) Pub. Date: Dec. 7, 2017

(54) METHODS AND SYSTEMS FOR MANAGING BOOKMARKS

(71) Applicant: vFLYER INC., San Francisco, CA (US)

(72) Inventor: Jonathan Aaron SPERLING, San Francisco, CA (US)

(21) Appl. No.: 15/611,770

(22) Filed: Jun. 1, 2017

Related U.S. Application Data
(60) Provisional application No. 62/392,464, filed on Jun. 2, 2016.

(51) Int. Cl. G06F 17/30; G06F 17/24; H04L 29/08

(52) U.S. Cl. CPC G06F 17/30884; H04L 67/025; G06F 17/241; G06F 17/30722

(57) ABSTRACT

A method and system for managing bookmarks is disclosed. A request is received by a processor from a user device to bookmark a web page. The processor provides a set of suggested tags based on algorithm to be used in the bookmarking of web page. The processor provides the capability to compare bookmarks in a table or updatable spreadsheet view. This capability is based on the support of attribute tags that have both a label and value of which the data type is recognized. The system provides the ability to create a communication channel between the user and the website in which they have bookmarked a web page.

### TECHNICAL FIELD

The present invention generally relates to web navigation and, more particularly, to a method and system for managing bookmarks during the web navigation.

### BACKGROUND

Typically, the Internet is used by a user to find information by navigating through one or more web pages of a website stored to internet—connected servers. Oftentimes, Uniform Resource Locator (URL) or such links of intended web pages are not handy with the users or users may not remember them at all. In such cases, users typically use online search portals to find the relevant information. However, this process may sometime be very time-consuming as the information may or may not be present in the top list of search results and the user may have to navigate through multiple search results to find the information. In such scenarios, the user may wish to save the links or contents of the most relevant web pages that are discovered so far. Almost all hypertext systems, including web browsers, provide a facility to bookmark/save links to the web pages for later retrieval. The bookmarked web pages are generally displayed as a list within the browser which may be selected later in “point-and-click” fashion by the user. Often the user may add new entries to the list, alter the URL associated with the web pages, reorder entries, or delete one or more entries from the list. Furthermore, the lists of bookmarked web pages/entries expand as the user's web browsing continues, quickly growing past a generally manageable size. It may become difficult for the user to organize the bookmarks from such a huge list and he may have to stick to the limited sorting mechanisms supported by the browser.

Further, it becomes difficult for the user to visually see a collection of bookmarks and the corresponding notes from the huge list. It becomes difficult to compare the bookmarks that were saved as the result of a specific search, for example, job openings, homes available, vacation plans, products, services, vehicles and the like. Moreover, a website owner/host of the web pages currently do not have any mechanism to determine if a web page is bookmarked on his/her website. In addition, there is no means available to follow up with users when a web page is bookmarked on the website. Furthermore, the website owner does not currently have an easy way to control/influence what information the user saves along with the bookmarked web pages. Furthermore, the website owner does not currently have a means to suggest contextual information such as physical street address of the user which can be presented to the user in the bookmarking process to enable him to not only have the text value of the address, but the context that the text value is an address which the user can later see on a map to get directions to the address.

Accordingly, there is a need to provide efficient solution for managing the bookmarks of the web pages. Further, there is a need to provide effective and easy retrieval and comparison of previously bookmarked web pages. There is also a need to provide a communication channel between the user and the website owner such that, for example, the website owner is enabled to send promotional offers related to the bookmarked web pages to the user.

### SUMMARY

Various methods and systems for managing bookmarks are provided.

In an embodiment, the method includes receiving, by a processor, at least one request generated from a User Interface (UI) of a user device to bookmark at least one web page. The method includes determining, by the processor, a set of relevant tags to be associated with the at least one web page. The set of relevant tags are determined, based at least in part, on previously bookmarked one or more web pages. The method facilitates, by the processor, the set of relevant tags on the UI. The method includes receiving, by the processor, a set of user inputted tags from the UI to bookmark at least one web page. The set of user inputted tags is at least one of the set of relevant tags and a set of user custom tags provided by a user of the user device. The set of user custom tags is different from the set of relevant tags and are generated by the user. The method includes storing, by the processor, the set of user inputted tags corresponding to the at least one web page for later retrieval purposes.

In another embodiment, a system for managing bookmarks includes at least one processor, a communication interface and a memory. The memory having stored therein machine executable instructions, that when executed by the at least one processor, causes the system to receive at least one request generated from a User Interface (UI) of a user device to bookmark at least one web page. The system is further caused to determine a set of relevant tags to be associated with the at least one web page. The set of relevant tags are determined, based at least in part, on previously bookmarked one or more web pages. The system is further caused to facilitate the set of relevant tags on the UI. The system is further caused to receive a set of user inputted tags from the UI to bookmark the at least one web page. The set of user inputted tags is at least one of the set of relevant tags and a set of user custom tags provided by a user of the user device. The set of user custom tags is different from the set of relevant tags. The system is further caused to store the set of user inputted tags corresponding to the at least one web page.

In another embodiment, a method for managing bookmarks is disclosed. The method receives, by a processor, at least one request generated from a User Interface (UI) of a user device to bookmark at least one web page. The method facilitates, by the processor, a set of relevant tags on the UI. The set of relevant tags are determined, by the processor in response to the request. The method receives, by the processor, a set of user inputted tags from the UI to bookmark at least one web page. The set of user inputted tags can include tags from both the set of relevant tags and a set of user custom tags provided by a user of the user device. The method stores, by the processor, the set of user inputted tags corresponding to the at least one web page. The method receives a communication request from the UI to communicate with a website representative device associated with the website. Thereafter, the method facilitates a communication between the user device and the website representative device based on the communication request.

Other aspects and example embodiments are provided in the drawings and the detailed description that follows.

### BRIEF DESCRIPTION OF THE FIGURES

For a more complete understanding of example embodiments of the present invention, reference is now made to the following descriptions taken in connection with the accompanying drawings in which:

FIG. 1 shows an example representation of an environment for managing bookmarks, in accordance with an example embodiment of the invention;

FIG. 2 shows an example representation of a user interface (UI) displayed for receiving a request for bookmarking a web page, in accordance with an example embodiment of the invention;

FIG. 3 shows an example flow diagram for bookmarking a web page, in accordance with an example embodiment of the invention;

FIG. 4 shows an example representation of a UI displayed for receiving a request for retrieving a bookmarked web page, in accordance with an example embodiment of the invention;

FIG. 5 shows an example flow diagram for retrieving a bookmarked web page, in accordance with an example embodiment of the invention;

FIG. 6 shows an example representation of a UI displayed for receiving a request for comparing previously bookmarked one or more web pages, in accordance with an example embodiment of the invention;

FIG. 7 shows an example flow diagram for comparing previously bookmarked one or more web pages, in accordance with an example embodiment of the invention;

FIG. 8 shows an example representation of a UI displaying a communication channel between a user and a representative of a bookmarked web page, in accordance with an example embodiment of the invention;

FIG. 9 shows an example flow diagram for subscribing a website to establish a communication channel between a user and a representative of a bookmarked web page, in accordance with an example embodiment of the invention;

FIG. 10 is a flow diagram of a method for managing bookmarks, in accordance with an example embodiment of the invention;

FIG. 11 is a flow diagram of another method for managing bookmarks, in accordance with an example embodiment of the invention;

FIG. 12 shows a block diagram representation of a system capable of implementing at least some embodiments of the present invention; and

FIG. 13 shows a computing device capable of implementing at least some embodiments of the present invention.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatuses and methods are shown in block diagram form only in order to avoid obscuring the present disclosure.

Reference in this specification to “one embodiment” or “an example embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

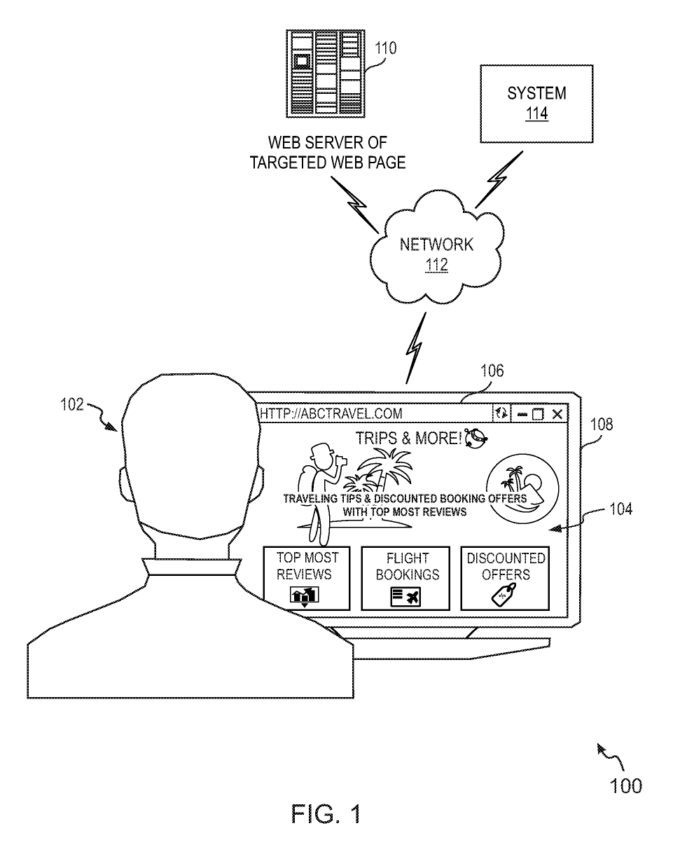

FIG. 1 shows an example representation of an environment 100 for managing bookmarks, in accordance with an example embodiment of the invention. The environment 100 depicts a user 102 accessing a web page 104 of a website using a web browser application 106 (hereinafter referred to as web browser 106) installed on a user device such as a desktop computer 108 (also referred to as ‘user device 108’). The website is depicted to include a collection of interlinked web pages accessible through corresponding unique URLs (Uniform Resource Locator) which organize the web pages into a hierarchical form to help the user 102 navigate through the one or more web pages. The web browser 106 may be configured to retrieve the one or more web pages such as the web page 104 associated with the website from a remote web server 110 (hereinafter referred to as web server 110) over a network 112 (hereinafter alternatively referred to as Internet 112). Examples of the network 112 may include wired networks, wireless networks or a combination thereof. Some examples of the wired networks may include Ethernet, local area network (LAN), fiber-optic cable network and the like. Some examples of the wireless networks may include cellular networks like GSM/3G/4G/CDMA networks, wireless LAN, blue-tooth or Zigbee networks and the like. An example of the combination of wired and wireless networks may include the Internet. In other example scenarios, instead of the desktop computer 108, any other electronic device such as a mobile phone, a PDA (Personal Digital Assistance), a tablet computer, a laptop computer and the like, can also be used to access the web page 104 from the web server 110.

In the environment 100, the web page 104 is exemplarily depicted to be displaying information related to travelling with an associated URL such as “http://abctravel.com”. The exemplary information may include one or more clickable images displaying reviews of various travel locations, flight booking information, available discounted offers and the like. In an example scenario, the user 102 may be interested in bookmarking the web page 104 as the web page 104 maybe important for the user 102. It is noted that bookmarking a web page is used herein as a reference to a URL accessible web page, image, fragment of text/contents from a web page, fragment of text (other contents) or placeholder for one of the previously mentioned options. Typically, the web browser 106 provides limited options to the user 102 to bookmark one or more web pages of his interest for later retrieval. These limited options include such as the URL names, titles and the like. In such scenarios, it may be a hurdle for the user 102 to retrieve the correct web page from a long list of bookmarked web pages because of such limited options. Various embodiments of the present technology provide methods and systems that are capable of overcoming these and other obstacles and providing additional benefits.

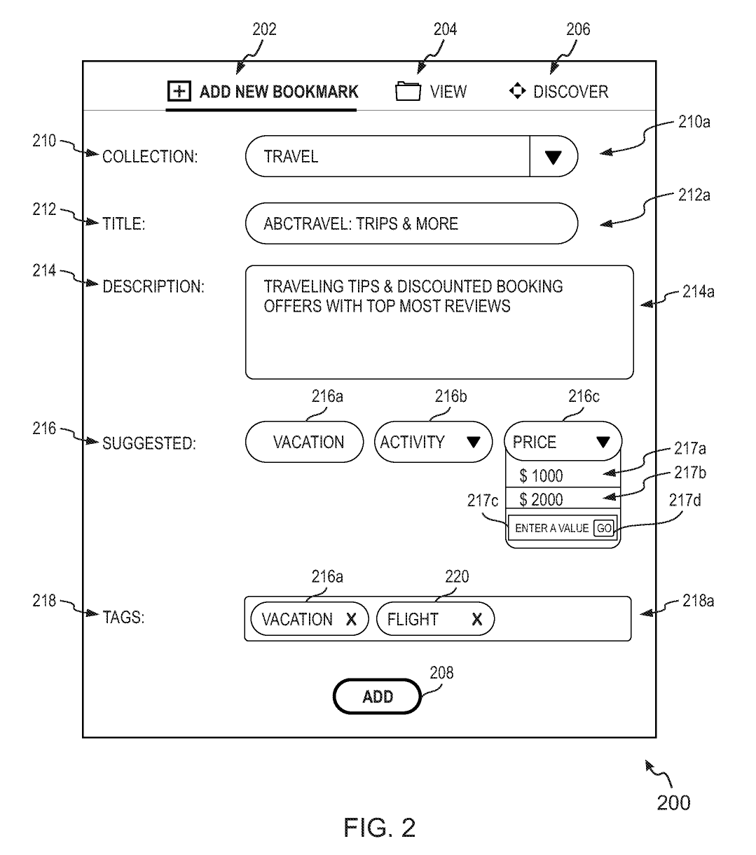

To that effect, the environment 100 is depicted to include a system 114 capable of managing bookmarks efficiently. More specifically, the system 114 may be configured to provide customized options to the user 102 for bookmarking the web page 104, for easily retrieving the bookmarked web page 104, and for comparing previously bookmarked one or more web pages. Further, the system 114 may be configured to establish a communication channel between the user 102 and at least one representative of the web page 104. The system 114 may be configured to set up a Website, a Web portal or may collaborate with a third-party website to serve as the online or Web interface for receiving one or more requests related to bookmarking the web page 104 from the user 102. In other example scenarios, at least some parts of the system 114 (or an instance of the system 114) may be configured as a plug-in or extension to the web browser 106 to provide various features of the present invention. Further, the system 114 may be configured as a suitable snippet, for example including but not limited to JavaScript that may be loaded into a browser toolbar menu of the web browser 106. When the bookmark is selected from the menu, the JavaScript function may be invoked. The user 102 may use the desktop computer 108 to access the online/Web interface over the network 112. The system 114 may be embodied as remote machine, such as for example a web server, including computer program instructions configured to manage bookmarks. In at least one example embodiment, the system 114 may cause display of an option (for example, in form of a widget or an icon) to receive request for bookmarking the web page 104 on the web interface. An example displayed on a UI associated with web platform is shown in FIG. 2

FIG. 2 shows an example representation of a user interface (UI) 200 displayed for receiving a request for bookmarking a web page, in accordance with an example embodiment of the invention. The UI 200 may be displayed on the desktop computer 108 to the user 102. It is noted that the website may include several UIs in addition to the UI 200. For example, there may be provided one or more UIs to display a list of bookmarked web pages, a comparison view to compare previously bookmarked web pages in user customized formats, one or more web pages bookmarked by other users (other than the user 102) which are marked publicly available and the like.

The UI 200 is exemplarily shown to depict clickable buttons 202, 204, 206, and 208 displaying text respectively “Add a new bookmark” (pre-selected), “View”, “Discover” and “Add”. The UI 200 is further depicted to show text-labels with corresponding clickable button and/or form fields for receiving the user's input such as text-label 210 “Collection” with clickable button 210a displaying text “Travel” as selected by the user 102 from a drop down menu. In other embodiments, the user 102 may be enabled to enter a new collection name and an associating collection type. It is noted that a collection is a set of relevant web pages or networked links or networked pages saved/bookmarked within a folder. A collection or a folder may alternatively hereinafter be referred to as a corral. In various embodiments, a set of collection types such as, but not limited to, articles, jobs, homes for rent, homes for sale, products, services and vehicles may be displayed as default collection types for user selection. Text-label 212 “Title” is displayed with corresponding from field 212a displaying text “abctravel: Trips and more”. Such auto-display is achieved through parsing the web page content and extracting a set of meta-tags from the content of the web page to present to the user 102. In alternate embodiments, such auto detection may be denoted as special suggestions provided by website. Text-label 214 “Description” with corresponding form field 214a “Travelling Tips and discounted booking offers with top most reviews” may be displayed. In alternate embodiments, the user 102 may be enabled to enter text of his choice in corresponding form fields of “Title” and “Description”.

Further, text-label “Suggested” 216 with corresponding clickable buttons 216a, 216b and 216c respectively displaying texts “Vacation”, “Activity” and “Price” are displayed on the UI 200. The user 102 may be enabled to select a set of relevant tags (such as “Vacation” (belongs to a set of standard tags), and “Activity” and “Price (belong to a set of attribute tags) as suggested by the system 114. For example, the user 102 may select “Vacation”. The attribute tag denoted with “Price” (see 216c) is shown with a dropdown menu that includes a price list denoted with form fields 217a and 217b “$1000” and “$2000” respectively, a form field 217c with text “Enter a value” where the user 102 may enter the price value of his own choice and a clickable button 217d “Go” to submit the entries.

Further the text-label 218 “Tags” with corresponding form field 218a may include a relevant tag 216a “Vacation” or a user custom tag 220 “Flight”. A set of such user custom tags may be inserted by the user based on his/her choice and these are different from the set of relevant tags (see, 216) suggested by the system 114. Such collection of the set of relevant tags and the set of user custom tags may hereinafter in combination be referred to as a set of user inputted tags (hereinafter alternatively also referred to as tags). In an embodiment, each of the set of user inputted tags can be a standard tag or an attribute tag, where each attribute tag contains either a label or a label paired with an associated value. It is noted that there may be zero or more elements in a set. When the user 102 has selected the set of user inputted tags, the user 102 may click on the button 208 “Add” to bookmark the web page 104. It is noted that a tag is used herein as a reference to a set of labels (also known as the set of standard tags), text-labels (also known as the set of attribute tags), tags with labels and values (also known as a set of context based attribute-value pairs), or other methods of identification that are saved along with bookmarks. These labels and/or tags are used to categorize the saved/bookmarked web page URLs and are used to more easily discover the web pages later.

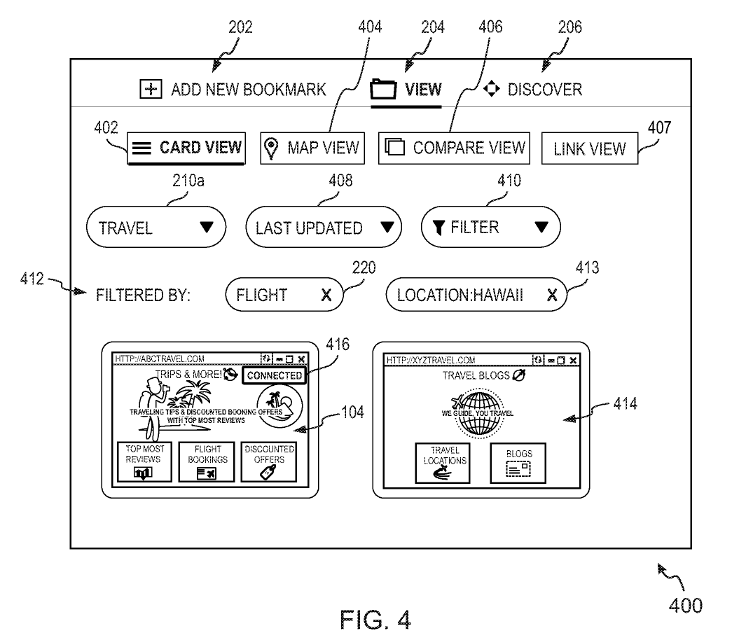

For example, “Location:Hawaii” (see 413, FIG. 4) is a context based attribute-value pair which has a label with associated value. The label and value may be separated, for instance, with a colon or otherwise, may be presented in other formats or without such separation. In an embodiment, value is at least one data type of a plurality of data types that include a string, an integer, a decimal number, a binary number etc., and the system 114 may be configured to interpret these data types which further provides facilities to better use such values in filtering the bookmarked web pages and providing more context to them. In an embodiment, the system 114 may dynamically create special attribute tags based on attribute tags that have numeric values. For example, if a user has bookmarked web pages into a collection with square footage attribute tags and values respective 800, 850, 900, 1000, 1100, 1500, 1600, 1625, 1650, the system 114 may evaluate the range of entries and cluster them to create the following special attribute tags: Square footage:800-1000, Square footage:1100-1500 and Square footage:1600-1650.

In an example embodiment, the user 102 may be enabled to enter a set of smart tags. If these smart tags are associated with a bookmarked web page, the system 114 may provide unique views to display the bookmarked web page containing the smart tags. For example, when a “Date” tag is associated with a bookmarked web page, the system 114 may be configured to display corresponding web page and other similarly tagged web pages on a calendar widget. As another example, for associated smart tag such as “Geo”, the corresponding bookmarked web page may be displayed on a map widget to provide a location by extracting the corresponding longitude and latitude values. As yet another example, for associated smart tag such as “Address”, the system 114 may perform lookups from third party services to acquire value options that a user might click to select. Therefore, when “Address” is entered and the user 102 starts typing, the system 114 may present matching address close to the user 102 based on IP (Internet Protocol), with the state, within the country, and based on other locations in the user's collection. Similarly, for associated smart tag “VIN”, a quick access to an accident report, estimated blue book value and other related information specific to the vehicle may be provided based on the Vehicle Identification Number.

In another example embodiment, the set of relevant tags may further include a set of sub-levelled relevant tags. For example, if “Vacation” tag is selected by the user 102, the system 114 may be configured to provide a set of other relevant tags such as, without limitation, “Lodging”, and “Transportation”. Further, if “Transportation” is selected, it might display another set of relevant tags such as “Car”, “Bus”, and “Plane”. In yet another example embodiment, a set of previously entered user custom tags may also be suggested to the user 102 as the set of relevant tags. In an example embodiment, the system 114 may support voting and ranking to facilitate a group of people providing input and automatically aggregating and displaying the aggregated results and individual votes and/or rankings on a corresponding UI.

In an embodiment, the provisioning of the user input corresponding to one or more buttons may cause one or more application programming interface (API) calls to the system 114 (shown in FIG. 1). The system may associate a Hyperlink Text Markup Language (HTML) tag or a JavaScript tag with the corresponding buttons, which may be activated upon receiving a respective user input. The activation of the tag may be configured to generate API calls to the system 114. The API calls may be embodied in form of a data signal capable of being securely transmitted over a communication network, such as the network 112. The system 114 upon receiving such a communication may be configured to cause display of one or more other UIs.

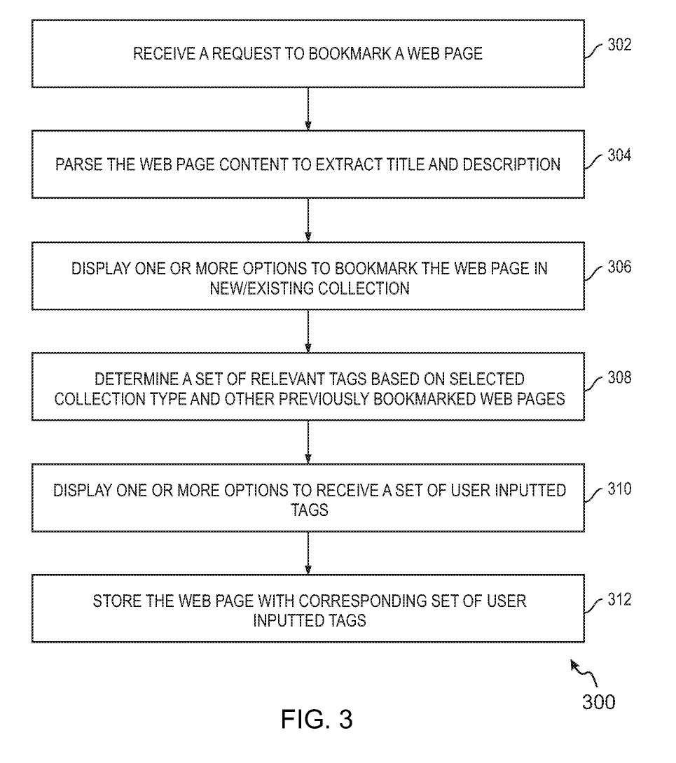

In an example embodiment, the button 204 “View”, when clicked by the user 102 may display a UI with corresponding option to retrieve previously bookmarked one or more web pages. Moreover, the button 206 “Discover”, when clicked by the user 102 may display a UI with corresponding collection of one or more publically displayed web page collection of other users. In some embodiments, one or more form fields may be implemented as free form text boxes or the form fields may include drop-down menus or may be associated with check-boxes to enable user selection of options. Further, instead of clickable buttons, there may be provided one or more widgets to perform similar functions. Steps required for bookmarking the web page 104 are explained hereinafter in detail with reference to FIG. 3.

FIG. 3 shows an example flow diagram 300 for bookmarking a web page, in accordance with an example embodiment of the invention. The various steps and/or operations of the flow diagram, and combinations of steps/operations in the flow diagram, may be implemented by, for example, hardware, firmware, a processor, circuitry and/or by an apparatus or by an electronic device of the user 102 or by a system such as the system 114 of FIG. 1 and/or by a different device associated with the execution of software that includes one or more computer program instructions. The method starts at operation 302.

At 302, a request to bookmark a webpage is received. As explained with reference to FIGS. 1 and 2, the user 102 may access the Internet 112 through the web browser 106 or a mobile application. The user 102 may be provided a UI to create an account with a remote server of the system 114. Post registration, UI 200 may be provided to the user 102 to request for bookmarking the web page 104. The request may include the URL to the web page 104 and/or all or part of the web page content. In cases where the system 114 doesn't receive all or part of the web page content, the system 114 may initiate an http or https request to fetch the content of the web page 104 to the web server 110 through the network 112.

At 304, the web page content is parsed to extract title and description. When the system 114 receives the web page content, the system 114 parses the web page content in order to find the page title that is contained between the <title> and </title> tags and the page description contained within the meta tag for description. This information may be auto-displayed to the user on the UI 200. For example, the text-label 212 “Title” is displayed with corresponding from field 212a displaying text “abctravel: Trips and more” extracted from the Meta tags content of the web page 104.

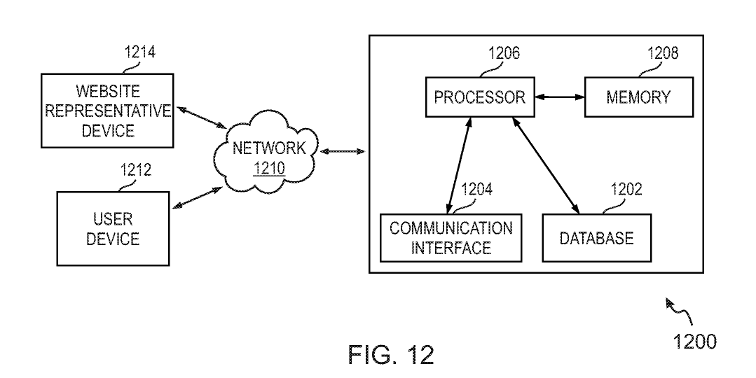

At 306, one or more options to bookmark the web page in new/existing collection are displayed. The system 114 may retrieve data from a database (such as the database 1202 as explained later with reference to FIG. 12) to support determination of default collection. The system 114 determines the default collection to be used based on one or more algorithms.

At 308, a set of relevant tags are determined based on selected collection type and other previously bookmarked web pages. The system 114 may evaluate the content of the web page 104, the user's previously bookmarked web pages, other users' publicly designated bookmarks to the web page 104, and the selected collection type of from among the default collection types provided to the user to create a relevancy ranked set of suggested/relevant tags.

At 310, one or more options to receive a set of user inputted tags are displayed. The system 114 is configured to display collection of the relevant tags and the user custom tags referred to as the set of user inputted tags. As displayed on the UI 200, the text-label 218 “Tags” with corresponding form field 218a may include user inputted tags being collection of the relevant tag 216a “Vacation” and the user custom tag 220 “Flight”. In an embodiment, if the user 102 enters a new collection type at the step 306, the system 114 may recalculate relevancy ranked set of tags and transmit the updated relevancy ranked set of tags to the user 102. The user 102 may select one of the new relevant tags or enter one of his choices or delete one of the previously added user inputted tags. Based on this, the system 114 may re-evaluate the set of relevant tags and transmit the updated relevancy ranked set of relevant tags for display.

At 312, the web page is stored with corresponding set of user inputted tags. Based on the user initialization action to bookmark the web page 104 i.e. by clicking the button 208 “Add” on the UI 200 of the FIG. 2, the system 114 receives the notification to save the web page 104, along with other information that the user 102 wants to store. In that case, the system 114 may make an http or https request to the web server 110 of the target web page 104 to retrieve additional information such as one or more images. The method ends at the step 312.

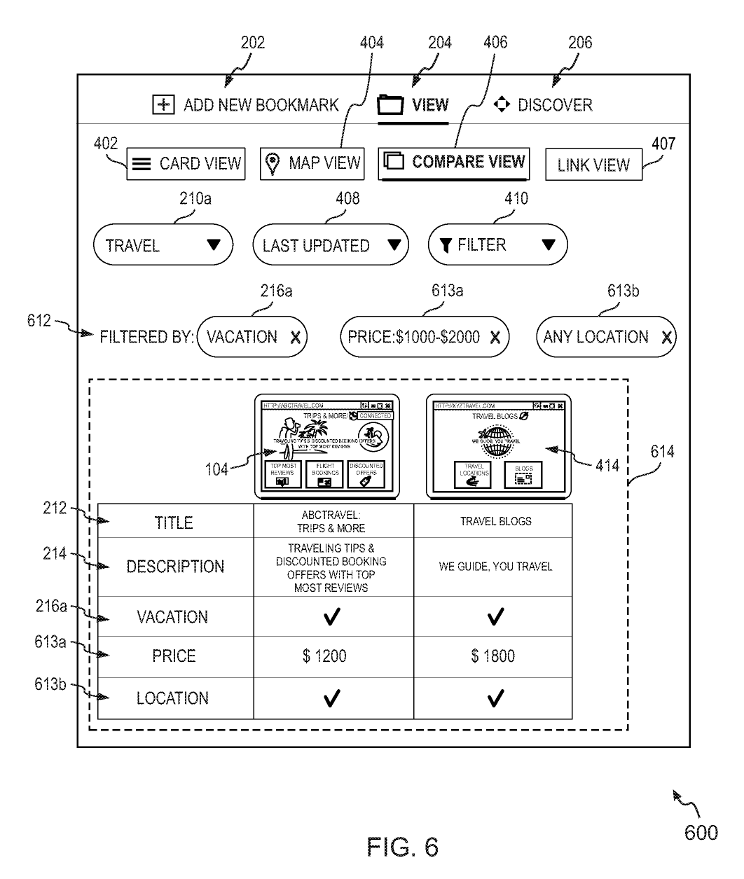

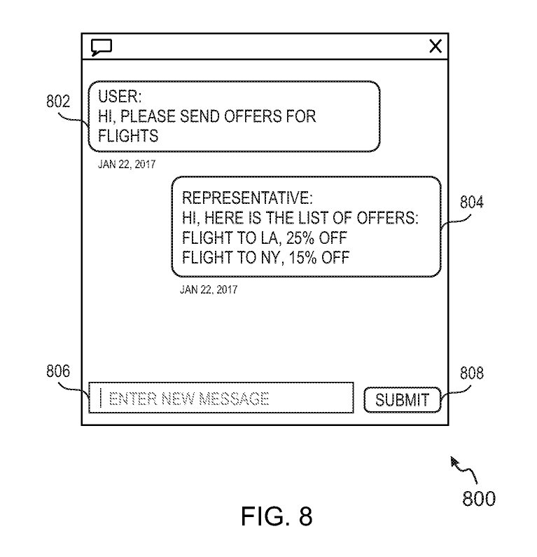

FIG. 4 shows an example representation of a UI 400 displayed for receiving a retrieval request for retrieving a bookmarked web page, in accordance with an example embodiment of the invention. The UI 400 is depicted to include clickable buttons/widgets 202, 204, and 206 with text displaying “Add a new bookmark”, “View” (pre-selected) and “Discover” respectively. For the clicked button 204 “View”, the UI 400 is further caused to display clickable buttons 402, 404, 406 and 407 with text displaying “Card view” (pre-selected), “Map view”, “Compare view” and “Link view” respectively. The UI 400 is depicted to display “Card view” according to present example embodiment. In other embodiments, when button 404 “Map View” is selected by the user 102, the bookmarked web pages may be displayed with corresponding locations on a map. Similarly, when the button 406 with “Compare view” is selected by the user 102, the comparison view of the one or more bookmarked web pages may be displayed. This is explained in detailed with reference to FIG. 6 later. When the button 407 “Link view” is selected by the user 102, a list of bookmarked web pages may be displayed to the user along with their respective tags and one or more provisions to edit or delete one or more bookmarked web pages. The UI 400 is further depicted to display a clickable button/widget 416 with the text displaying “Connected”. When clicked by the user 102, the system 114 may be configured to display a UI corresponding to establishing a communication channel between the user 102 and at least one representative of the bookmarked webpage. This is explained in detail with reference to FIG. 8 later.

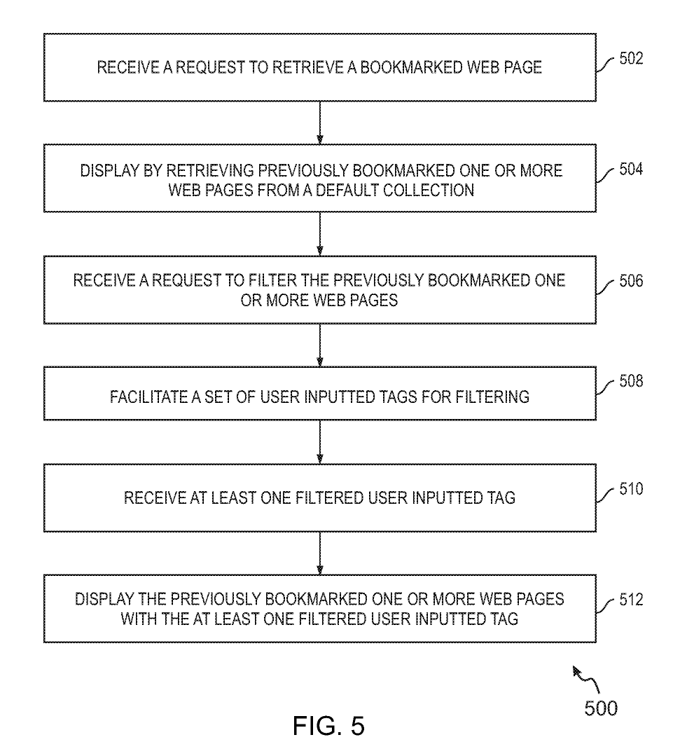

The UI 400 is further depicted to display buttons 408 and 410 with text displaying “Last updated” and “Filter”. In an embodiment, the user 102 may be enabled to sort the display of bookmarked web pages by selecting other options from the dropdown menu of the button 408, such as “First updated”, “Title”, “Topic” and the like. The button 410 with the text “Filter”, when selected/clicked by the user 102, is configured to display a set of user inputted tags associated with the one or more bookmarked web page for user selection for filtering. The UI 400 further displays the user custom tag 220 “Flight” and the context based attribute-value pair 413 “Location:Hawaii” as “filtered by” (text-label 412) the user 102 from the list of user inputted tags provisioned to him and the form field 210a displaying the collection type “Travel”. Based on filtering criteria received from the user 102, the system 114 may be configured to display one or more bookmarked web pages containing the tags “Flight” and “Location:Hawaii”. To that effect, the UI 400 displays the web page 104 of the FIG. 1 and one or more exemplary web pages such as a web page 414 having tag “Flight” and “Location:Hawaii” and being saved previously by the user 102. In an example embodiment, the web page 414 includes URL such as http://xyztravel.com and corresponding web content. In an embodiment, the system 114 may display one or more bookmarked web pages based on zero or more filter attributes (i.e. without receiving any user input for filtering). In an embodiment, the set of user inputted tags to be filtered may be facilitated based on a set of values and accordingly bookmarked web pages are retrieved by interpreting the data type of the set of values. Steps required for retrieving the bookmarked web page 104 are explained hereinafter in detail with reference to FIG. 5.

FIG. 5 shows an example flow diagram 500 for retrieving a bookmarked web page, in accordance with an example embodiment of the invention. The various steps and/or operations of the flow diagram, and combinations of steps/operations in the flow diagram, may be implemented by the system 114 of the FIG. 1 and/or by a different device associated with the execution of software that includes one or more computer program instructions.

At 502, a retrieval request to retrieve a bookmarked web page is received. As explained with reference to FIG. 4, the user 102 may click the button 204 “View” to make the request using the web browser 106 running on the desktop computer 108. The remote server of the system 114 may be configured to invoke one or more APIs associated with the request to take further actions.

At 504, previously bookmarked one or more web pages are displayed by retrieving form a default collection. Based on the user's request to view the bookmarked web pages, the system 114 retrieves data related to the bookmarked web pages from the database. As explained with reference to FIG. 4, the form field 210a displaying the collection type “Travel” is a default collection type from which previously bookmarked one or more web pages are retrieved by the system 114. Further, the system 114 transmits the html content through the Internet 112 to the user 102 to display on the web browser 106.

At 506, a request to filter the previously bookmarked one or more web pages is received. The user 102 may choose to filter the bookmarked web pages in a specific collection or search across all collections/corrals using the UI 400 by clicking the button 410 “Filter”. By receiving such request, the system 114 may request the data related to the bookmarked web pages from the database.

At 508, a set of user inputted tags are facilitated (e.g., provided to the user device) for filtering. For example, the system 114 provides a list containing tags T1, T2, T3 . . . Tn to the UI of the user device 108. In an embodiment, the system 114 determines the ranked list of tags globally or in a specific collection based on the number of occurrences of a corresponding user inputted tag. The user 102 is enabled to select one or more user inputted tags from the set of ranked user inputted tags provided by the system 114. Further, the system 114 is configured to recalculate and regenerate the ranked set/list of remaining user inputted tags that are included in the bookmarked web pages containing the previously selected user inputted tag by the user 102 for filtering. The regenerated ranked list of the remaining user inputted tags are provisioned to the user 102 so that he may continue to select more user inputted tags as filters or remove one or more from a list of filtered user inputted tags. The process of ranking the user inputted tags continues until the user completes the filtering. In an example embodiment, after the user 102 has added or removed a user inputted tag for filtering, the system 114 may display other filtered tags that are contained in one or more web pages in the default collection, account, or other public or private system. The system 114 may optionally further display the occurrences of those filtered tags in individual bookmarked web pages. In another example embodiment, the system 114 may enable the user 102 to provide inputs of the tags that should not be considered for filtering. For example, a collection contains 10 bookmarked web pages and 8 of which contain the attribute tag “Vacation Rentals”. The user may be able to filter to show all the web pages that do not contain the tag “Vacation Rentals”. Further, if there is a filter request, then the set of filters will have one or more filters to be provisioned to the user 102. However, in the scenarios, when the specific request is not made by the user 102, the set of filters may have zero elements. Additionally, the user 102 can use a keyword search filter which may be considered by the system 114 while building the list of bookmarked web pages to display.

At 510, at least one filtered user inputted tag (for example, the tag ‘T3’) is received. The user selected filtered user inputted tags are provided on the UI of the user device 108. As explained with reference to FIG. 4, the UI 400 displays the tags “Flight” (see 220) and “Location:Hawaii” (see 413) as filtered by (see text-label 412) the user 102 from the list of user inputted tags provisioned to him for filtering purposes.

At 512, the previously bookmarked one or more web pages with the at least one filtered user inputted tag (T3) are displayed. For instance, if web pages WP3a, WP3b, WP3c are bookmarked web pages associated with the tag T3, the web pages WP3a, WP3b, WP3c are displayed to the UI of the user device 108. In an embodiment, when the system 114 receives the request to apply the set of user inputted tag filters, it generates html content that contains the user's bookmarked web pages that have the user inputted tag specified in the user's request to filter. The system 114 transmits the html content to the user 102 to be displayed on the user's web browser 106.

FIG. 6 shows an example representation of a UI 600 displayed for receiving a comparison request for comparing previously bookmarked one or more web pages, in accordance with an example embodiment of the invention. When the button 406 with text

“Compare view” is selected by the user 102 on the UI 400 of the user device 108, the system 114 is configured to cause a display of the UI 600. As explained in detail with reference to FIG. 4, by clicking the buttons 408 and 410 with text displaying “Last updated” and “Filter”, the user 102 may be enabled to select one or more filtered user inputted tags (e.g., a set of tag filters) also for requesting the comparison view on the UI 600. To that effect, the UI 600 displays the tags “Vacation” (see 216a), “Price:$1000-$2000” (a context based attribute-value pair denoted as 613a) and “Any Location” (an attribute tag denoted as 613b) as “filtered by” (text-label 612) the user 102 from the set of user inputted tags provisioned to him for the default collection type “Travel”. Based on filtering criteria received from the user 102, the system 114 may be configured to display a table 614 with one or more bookmarked web pages containing the filtered tags. For example, for the filtered tag “Price:$1000-$2000” the system 114, among other capabilities, may be able to display only the bookmarked web pages that contain an attribute tag with the price greater than or equal to 1000 and price less than or equal to 2000. It should be noted that the any view including the comparison views, to be displayed on the UI, can also be requested by the user without including any filters or either standard or attribute tags.

In the illustrated embodiment, columns of the table 614 are displayed with the web page 104 and the web page 414. Rows of the table 614 are displayed with corresponding text-labels 212 and 214 displaying the texts “Title” and “Description” respectively. As explained with reference to FIG. 2, the text-label 212 “Title” is displayed with corresponding from field 212a displaying text “abctravel: Trips and more” and the text-label 214 “Description” is displayed with corresponding form field 214a “Travelling Tips and discounted booking offers with top most reviews”. Similarly, the form fields associated “Title” and “Description” of the web page 414 may also be displayed. The table 614 may further include a row with the filtered tags being used as the tags in both the web pages 104 and 414 displayed with a representation such as a tick mark (✓). The table 614 may also include one or more rows with other user inputted tags determined based on the rank-ordered list of the user inputted tags available in the database of the system 114 corresponding to the each web page. Further, the user 102 may be enabled to enter a value of his choice in the corresponding cell values for the filtered tag “Price: :$1000-$2000” (see 613a), such as denoted by the values “$1200” for the web page 104 and “$1800” for the web page 414.

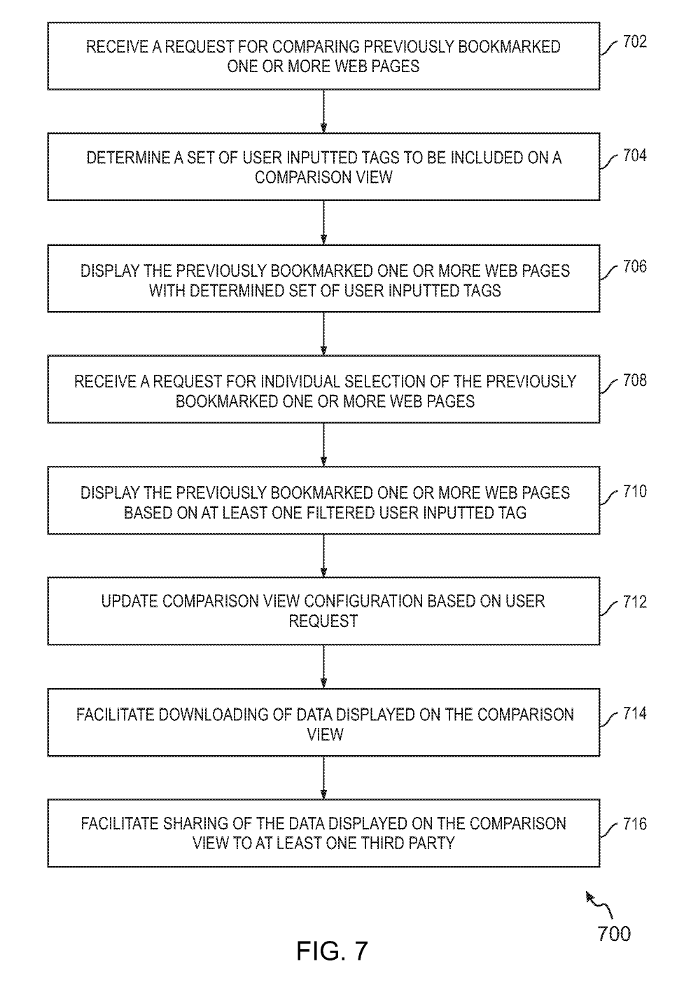

In an example embodiment, the UI 600 may further include a clickable button with text “Customize” (not shown) by clicking which the user 102 may be enabled to add or remove tags from being displayed on the comparison view. In an embodiment, the user 102 may be enabled to modify the provisioned information related to the bookmarked web pages on any view or on any UI. For example, the user 102 may be capable of modifying the title of the web page 104 being displayed on the table 614 of the UI 600 provisioned to display comparison view of the one or more bookmarked web pages. Further, the user 102 may be enabled to add new tags or to change values of the label-value pairs (attribute-value pairs) at any given instant on any configured UI. Steps required for comparing the previously bookmarked one or more web pages are explained hereinafter in detail with reference to FIG. 7.

FIG. 7 shows an example flow diagram 700 for comparing previously bookmarked one or more web pages, in accordance with an example embodiment of the invention. The various steps and/or operations of the flow diagram, and combinations of steps/operations in the flow diagram, may be implemented by the system 114 of the FIG. 1 and/or by a different device associated with the execution of software that includes one or more computer program instructions.

At 702, a request for comparing previously bookmarked one or more web pages is received. As explained earlier, the user 102 may use the Internet 112 (the network 112) to request on the web browser 106 running on the user device 108 by clicking the button 406 “Compare view”. In an embodiment, the at least one comparison request includes receiving a selection of at least one of a set of labels and a set of values from the user.

At 704, a set of user inputted tags are determined to be included on a comparison view. The system 114 retrieves data related to the user's bookmarks from the database. The system 114 evaluates the user's bookmarks (bookmarked web pages) to determine a set of user inputted tags to include on the comparison view based on being tagged on any one web page in a designated collection. The designated collection is configured to store one or more relevant web pages. For example, as explained with reference to FIG. 1, the form field 210a displaying the default collection type “Travel” may include one or more relevant web pages such as the web page 104 and the web page 414. In an embodiment, the system 114 may, by default, consider a set of previously entered user custom tags as relevant for all the bookmarked web pages of a specific/default collection type. The user 102 can choose to restrict some of such tags to be relevant for only a specified web page. The user 102 can also choose to make a tag relevant to all the bookmarked web pages amongst all the collection types. In an embodiment, the system 114 may retrieve previously saved comparison view configuration (hereinafter referred to as configuration) from the database. The configuration may be inspected to retrieve information such as for example, tags to be excluded on the comparison view or preferred sort order of the tags and the like. Further, if there are tags that are not found in the list of tags in the configuration, the systems 114 updates the configuration to include them. The system 114 may include tags designated in the configuration to display even if there are no instances of such tag in the designated collection or filtered list of bookmarked web pages from this designated collection.

At 706, the previously bookmarked one or more web pages with determined set of user inputted tags are displayed. The system 114 generates html content for the display of the comparison view such as the UI 600. This content includes a table such as the table 614 with the columns representing bookmarked web pages 104 and 114 and rows representing the determined tags associated with the web pages. In an example embodiment, each cell of the table 614 may be populated with the value of the saved web page and attribute tag combination if it exists. In another example embodiment, the system 114 may optionally display the bookmarked web pages on each row and corresponding tags on each column. Further, the system 114 may display other tags of the bookmarked web pages in the table 614 such as but not limited to the “Title”, “Description”, primary image or a rating attribute enabling the user to rate the web pages based on their importance. The system 114 sends corresponding html content to the user's web browser 106 for display.

At 708, a request is received for individual selection of the previously bookmarked one or more web pages. The system 114 may be configured to facilitate the individual selection of the previously bookmarked one or more web pages by the user 102 to be included on the comparison view. The user 102 clicks on web link to initiate process to individually select a set of bookmarked web pages to include on the comparison view. In an embodiment, the system 114 generates html content that includes the ability for user 102 to indicate selection of bookmarked web pages on one by one basis. The system 114 includes only the bookmarked web pages from the designated collection which has the tags same as the filtered tags selected by the user 102.

At 710, the previously bookmarked one or more web pages are displayed based on at least one filtered user inputted tag. As explained with reference to FIG. 6, based on the filtering criteria received from the user 102, the system 114 may be configured to display a table 614 with the one or more bookmarked web pages (such as the web page 104 and the web page 414) containing the filtered tags such as “Vacation” (see 216a), “Price:$1000-$2000” (see 613a) and “Any Location” (see 613b) on the UI 600. The system 114 applies the similar logical operations as explained in the step 704 to produce the html content containing the comparison view to include the bookmarked web pages individually selected by the user 102. In various embodiments, instead of a table, a spreadsheet or a summary view may be created. In an example embodiment, the user 102 may be enabled to update a value in a cell in the table 614. For example, the user may update the value (in form field associated with the tag) associated with the attribute tag 613b “Any Location” to “Locations only from East Coast” for the web page 104. The system 114 updates the database for the web page 104 with the modified attribute value.

At 712, comparison view configuration is updated based on user request. The system 114 generates html content of the comparison view configuration screen based on the current configuration retrieved from the database upon receiving the user request. In an embodiment, the user may add new tags for display, modify hidden tags to be displayed, modify displayed tags to hidden, re-order the display of tags, reduce prominence of the tags on the display and change the style of the table 614 including but not limited to fonts types, colors, background, alternating row color, font size and the like. Further, an option to automatically suppress rows or other displays for tags that do not have any values, or that have specific values or ranges of values for the displayed set of web pages, may be facilitated. The system 114 processes the request to update the comparison view configuration and updates the database with the changes as specified by the user 102. The updated comparison view may be displayed to the user 102 on a corresponding UI.

At 714, downloading of data displayed on the comparison view is facilitated. In an embodiment, the user 102 may request to download the data presented on the table 614 of the UI 600. The downloading of the data may be facilitated in one or more formats such as but not limited to .csv, .xls files and the like. The system 114 transmits the generated download file to the user 102.

At 716, sharing of the data displayed on the comparison view is facilitated to at least one third party. In an example embodiment, the user 102 may request the data of the table 614 to be published and/or shared with the at least one third party service/person. To that effect, the system 114 may be configured to support authorization with the user's account on such third party service. The system 114 may support the API of the other service to add, update, or remove the content to be published. The at least one third party services may include, for example, social media websites such as Facebook® and/or Twitter®. The user 102 may be enabled to share the data to one or more other persons via emails as well.

FIG. 8 shows an example representation of a UI 800 displaying a communication channel between a user and a representative of a bookmarked web page, in accordance with an example embodiment of the invention. As mentioned in FIG. 4, the UI 400 is depicted to display a clickable button/widget 416 with the text displaying “Connected” on the web page 104. When clicked by the user 102, the system 114 may be configured to display the UI 800 corresponding to establishing a communication channel between the user device 108 and the at least one website representative device (hereinafter alternatively referred to as representative device/website owner) of the bookmarked web page 104. Herein, the website representative device represents any system or device (standalone or distributed) that is used for managing and/or controlling the operations of the website, or is authorized for conducting any form of communication with users of the website and/or the system 114. The website representative device may normally be operated by one or more authorized representatives or agents of the website's organization. The button 416 “Connected” of the UI 400, designates an identification mark to display availability of the at least one communication channel between the user 102 and the representative of the bookmarked web page 104. In other example embodiments, the identification mark/the button 416 may be displayed as any type of symbolic visual indicator. In this example embodiment, the at least one bookmarked web page 104 may be referred as the at least one connected bookmarked web page 104 because of the availability of the communication channel. The representative of the website may request to connect/verify ownership of the associated domain name (or URL of home page) to enable one or more of the web pages (such as the web page 104) of the website be shown with the identification mark for communicating with the user 102.

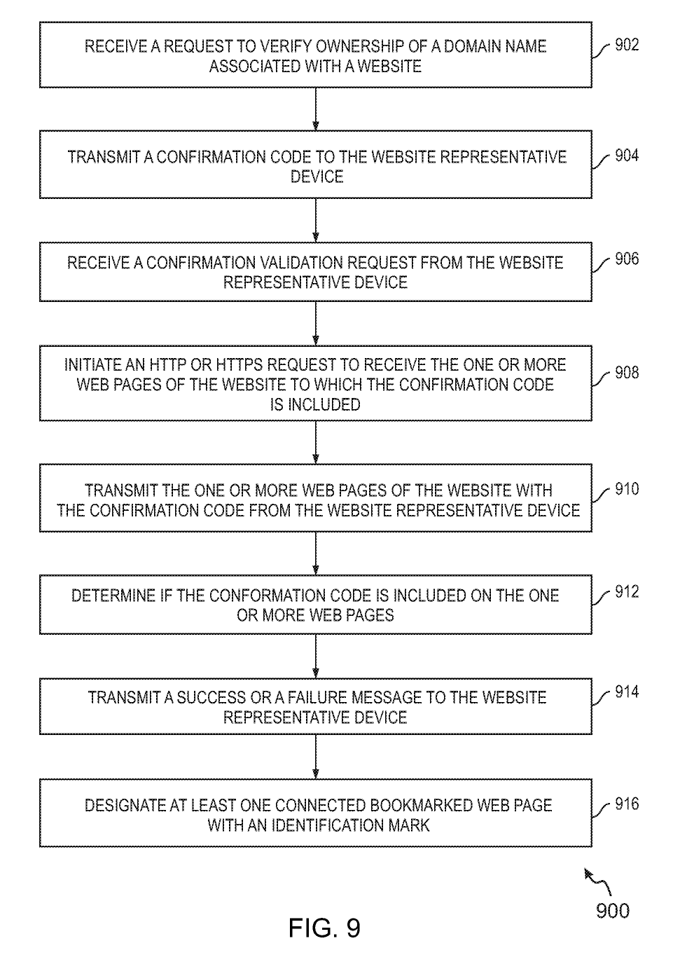

The UI 800 is depicted to provision previous communications between the user 102 and the representative of the bookmarked and the connected web page 104 such as a message 802 initiated by the user on date Jan. 22, 2017 displaying “Hi, Please send offers for flights” and a message 804 replied by the representative of the web page 104 on the same date displaying “Hi, here is the list: Flight to LA, 25% OFF; Flight to NY 15% OFF”. Further the UI 800 displays a form field 806 with text “Enter a new message” for enabling the user 102 to enter text/query for communicating with the representative. After entering the message, the user may click button 808 displaying text “Submit” in order to send the message to the representative. In an embodiment, the representative may be any person authorized by website owner including one or more licensees. In another embodiment, the message from the user 102 may be sent by the user 102 to one or more authorized representatives of the website through multiple communication channels at any given time instance. Further, the message may alternatively be sent via an email, a text message, or by a call. Steps required for establishing the communication channel are explained hereinafter in detail with reference to FIG. 9.

In an example embodiment, any website owner, through his representative devices may contact the system 114 to connect his website with the system 114. One primary benefit of subscribing the website with the system 114 includes offering a communication between any user who has bookmarked a web page of the website and a representative device of the website (or website server 110). As described with reference to FIG. 8, such communication is initiated by the user using the identification mark configured on the bookmarked web page associated with the website. In one embodiment, whenever a new user (e.g., a user X), via his user device, bookmarks a web page associated with the website through the system 114, the system 114 notifies the representative device of the website that the user X has recently bookmarked the web page. Additionally or optionally, the system 114 also provides the representative device an option to send messages, emails or such communications via the system 114. In some other forms, the system 114 may even facilitate a direct communication between the representative device and the user device.

FIG. 9 shows an example flow diagram 900 for subscribing a website to establish a communication channel between a user and a representative of a bookmarked web page, in accordance with an example embodiment of the invention. The various steps and/or operations of the flow diagram, and combinations of steps/operations in the flow diagram, may be implemented by the system 114 of the FIG. 1 and/or by a different device associated with the execution of software that includes one or more computer program instructions.

At 902, a request is received to verify ownership of a domain name (or any particular URL for example Home page URL) associated with a website. For instance, any website representative may access the Internet 112 through a web browser on the representative device and send a request to the remote server of the system 114 to verify ownership of the domain name/URL associated with the website for utilizing one or more features of the present invention. The website owner may include one or more email addresses, phone numbers or other contact information to receive notifications related to one or more web pages from the connected website being bookmarked by the user 102. The system 114 processes the request to verify ownership of the domain name and updates the database for the registration of the domain name of the website.

At 904, a confirmation code (unique ID) to the website representative device is transmitted. Subscription of the website is facilitated based on the confirmation code sent by the system 114 to the website representative device. In an embodiment, the system 114 may also transmit the instructions to be followed for the subscription process along with the confirmation code.

At 906, a confirmation validation request is received from the website representative device. The website representative device may include the confirmation code to one or more web pages of the website and send a request for validation of the same to the system 114.

At 908, an http or https request is initiated to receive the one or more web pages of the website to which the confirmation code is included.

At 910, the one or more web pages of the website with the confirmation code are transmitted from the website representative device. The website's web server such as the web server 110 may send back the html of all the web pages with the confirmation code to the system 114.

At 912, it is determined if the conformation code is included on the one or more web pages. The system 114 may parse the html sent by the web server 110 to determine whether the confirmation code is included on the web pages.

At 914, a success or a failure message is transmitted to the website representative device. The system 114 may transmit such message to the representative device for notifying the subscription of the website. The system 114 may update the database to indicate that the website subscription is confirmed if the confirmation code is included in the web page content.

At 916, at least one connected bookmarked web page is designated with an identification mark. As explained with reference to FIG. 4 and FIG. 8, the web page 104 may be depicted to include the clickable button 416 “Connected” as the website of the web page 104 is already connected with the system 114 at 904. As shown in FIG. 4, the bookmarked web page 414 is not shown with any such identification mark, since the corresponding website may not have been verified the ownership with the system 114. The method ends at the step 916.

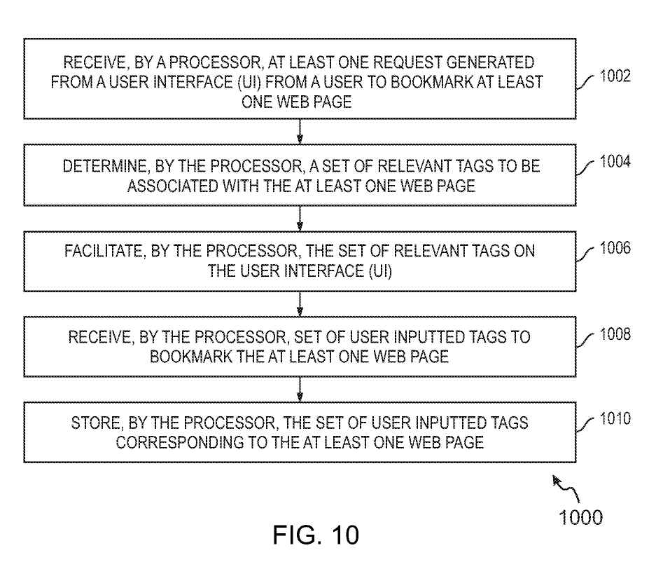

FIG. 10 is a flow diagram 1000 of a method for managing bookmarks, in accordance with an example embodiment of the invention. The various steps and/or operations of the flow diagram, and combinations of steps/operations in the flow diagram, may be implemented by, for example, hardware, firmware, a processor, circuitry and/or by an apparatus or by an electronic device of the user 102 or by a system such as the system 114 of FIG. 1 and/or by a different device associated with the execution of software that includes one or more computer program instructions. The method starts at operation 1002.

At 1002, at least one request to bookmark at least one web page on a UI of a user device is received. The request is received from the user device. As explained with reference to FIGS. 1-2, the user 102 may wish to bookmark the web page 104 retrieved from the web server 110 using the web browser 106 running on the user device 108. The UI 200 may be provisioned to the user 102 through which the user 102 may make the request to bookmark the web page 104. In various embodiment, the user 102 may be enabled to make such request using a snippet of JavaScript loaded into toolbar of the web browser 106, through an installed browser extension/plug-in, through a mobile application, through an add button configured to always be displayed on each page within the application, through an email or the like. In various embodiments, the user 102 may be enabled to provide one or more inputs using voice commands, gesture inputs or combinations.

At 1004, a set of relevant tags to be associated with the at least one web page are determined. The set of relevant tags is generated, based at least in part, on previously bookmarked one or more web pages.

At 1006, the set of relevant tags are facilitated on the UI. As explained with reference to FIG. 2, the set of relevant tag such as 216a, 216b, and 216c respectively displaying “Vacation”, “Activity” and “Price” may be provisioned on the UI 200 for the user selection.

At 1008, a set of user inputted tags to bookmark the at least one web page is received. The set of user inputted tags is at least one of the set of relevant tags and a set of user custom tags provided by the user. The set of user custom tags is coined by the user and it is generally different from the set of relevant tags provided by the system 114.

At 1010, the set of user inputted tags corresponding to the at least one web page is stored. The database of the system 114 may be configured to store the set of user inputted tags corresponding to the at least one web page.

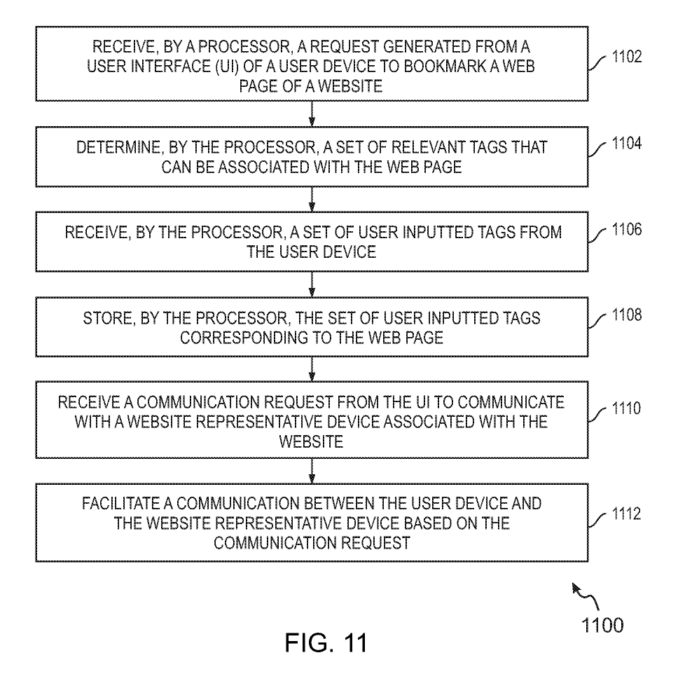

FIG. 11 is a flow diagram of yet another method 1100 for managing bookmarks of web pages and facilitating communication between users and devices associated with websites of the web pages, in accordance with an example embodiment of the invention. The various steps and/or operations of the flow diagram, and combinations of steps/operations in the flow diagram, may be implemented by, for example, hardware, firmware, a processor, circuitry and/or by an apparatus or by an electronic device of the user 102 or by a system such as the system 114 of FIG. 1, the web server 110 and/or by a different device associated with the execution of software that includes one or more computer program instructions.

At 1102, the method 1100 includes receiving a request by a processor (e.g., the system 114). The request is generated from a UI of a user device (e.g., the user device 108) to bookmark a web page of a website.

At 1104, the method 1100 includes determining a set of relevant tags (T1 to Tn) that can be associated with the web page. The set of relevant tags are initial candidates determined by the processor, one or more tags of which can be selected as a bookmark tag.

At 1106, the method 1100 includes receiving a set of user inputted tags from the user device. The set of user inputted tags may be any one of the set of relevant tags (T1 to Tn) or a set of user custom tag (Tc). The tag Tc may be provided by the user, and it may not be present in the set of tags T1 to Tn. For example, the user 102 may have selected tag T3, and the tag T3 is communicated to the processor.

At 1108, the method 1100 includes storing the set of user inputted tags (for example, T3) corresponding to the web page. Once the bookmarked page of the web site is stored with the tag T3, the user 102 may at any point of time be able to access the bookmarked page using the tag T3.

At 1110, the method 1100 includes receiving a communication request from the UI to communicate with a website representative device associated with the website. As explained with reference to FIG. 8, when the user 102 wants to communicate with the representative of the website, he may click the button 416 “Connected” to make the request.

At 1112, the method 1100 includes facilitating a communication between the user device and the website representative device based on the communication request. The system 114 generates html content for a communication screen such as the UI 800 based on the communication request. Such provisioning of the communication is already explained with reference to FIG. 8, and it is not described again for the sake of brevity. For instance, the user 102 may use an identification mark representing ‘initiate a communication with website representative’ on the bookmarked page displayed on the UI to establish the communication facilitated by the system 114. The system 114 may be configured to process the request by looking up in the database for preferred communication channels of the website representative to receive the messages from the user 102. Further, the system 114 may be configured to lookup in the database for preferred communication channels of the user 102 to receive the response message from the website representative. For example, the user 102 and the website representative may communicate with each other through a mobile application. In various embodiments, the website representative device may be enabled to provide promotional offers to the user 102, or otherwise communicate or connect with the user 102 who has bookmarked the web page 104. In an example, the user 102 may also be enabled to configure one or more settings to accept these updates from the website representative device or to ignore them. In an example, the system 114 may support a set of tags which may be used by the website representative device to embed in one or more web pages of the website. Further, the website representative may define unique tags of his own which may be made available as suggestions to the user 102 and be designated in a way to clarify that the website representative provided these unique tags.

FIG. 12 shows a block diagram representation of the system 114 capable of implementing the various embodiments of the present invention. The system 114 includes a database 1202, a communication interface 1204, at least one processor 1206 and a memory 1208 for managing the bookmarks. In at least one embodiment, the system 114 may be embodied as a server accessible through a communication network, such as the network 1210. The processor 1206 is communicably coupled with the database 1202, the communication interface 1204 and the memory 1208. The processor 1206 is capable of executing the stored machine executable instructions in the memory 1208 or within the processor 1206 or any storage location accessible to the processor 1206. The processor 1206 is configured to perform the various operations as explained hereinabove with reference to various methods. For example, the processor 1206 is configured provision one or more UIs to the user 102 using the communication interface 1204. The processor is configured to receive on the UI, at least one request related to bookmarking the web page 104, retrieving the bookmarked web page 104 from the database 1202, and communicating with a representative of the bookmarked web page 104. Further, the processor 1206 is configured to use one or more algorithms to evaluate a set of relevant tags to be provisioned to the user 102. The processor is configured to receive a set of user custom tags from the user 102 for bookmarking the web page 104. In an embodiment, the processor 1206 may be configured to retrieve the web page 104 by receiving at least one filtered tag from the user 102. The processor 1206 may be configured to establish a communication channel between the user 102 and the representative of the web page 104 based on subscription of the associated domain name. The processor 1206 may be embodied in a number of different ways. In an embodiment, the processor 1206 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The memory 1208 may be embodied as a storage device embodied as one or more volatile memory devices, one or more non-volatile memory devices, and/or a combination of one or more volatile memory devices and non-volatile memory devices, for storing micro-contents information and instructions. The database 1202 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash ROM, RAM (random access memory), etc.).

The database 1206 may be embodied as a non-volatile storage location capable of storing data such as data related to one or more web pages to be bookmarked, one or more bookmarked web pages, a set of associated tags, a set of filtered tags, account information of the user 102, the contact information of the web site owner, one or more configurations created by the user 102 for comparison view of the bookmarked web pages, domain names associated with the connected websites, information of third party persons/services with which the user 102 wishes to share/publish the bookmarked web pages, one or more communication channel preferences of the user and the representative and the like. The database 1202 may also include algorithms, such as machine learning algorithms to determine relevant tags.

The communication interface 1204 is configured to communicate with external devices (e.g., a user device 1212 and a website representative device 1214). The interface 1204 communicates with these external devices for sending information provided by the processor 1206 to manage user interfaces (UIs) on these devices and to receive information provided by UIs of these devices and provide the received information to the processor 1206. The UIs on the external devices are configured to display information based on one or more actions performed by the processor 1206 based on the user request. In an embodiment, the communication interface 1204 is capable of facilitating operative communication with the user device 1212 and the website representative device 1214, using API calls. The communication may be achieved over a communication network, such as the network 1210, for managing bookmarks as explained with reference to FIGS. 1 to 11. In an example embodiment, the communication interface 1204 may include mechanisms configured to receive inputs from and provide outputs to the user 102. To that effect, the communication interface 1204 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a microphone, a speaker, a ringer, a vibrator, and the like. In an embodiment, the user 102 may use the user device 1212 to access the user interfaces of the communication interface 1204 and interact with the system 114.

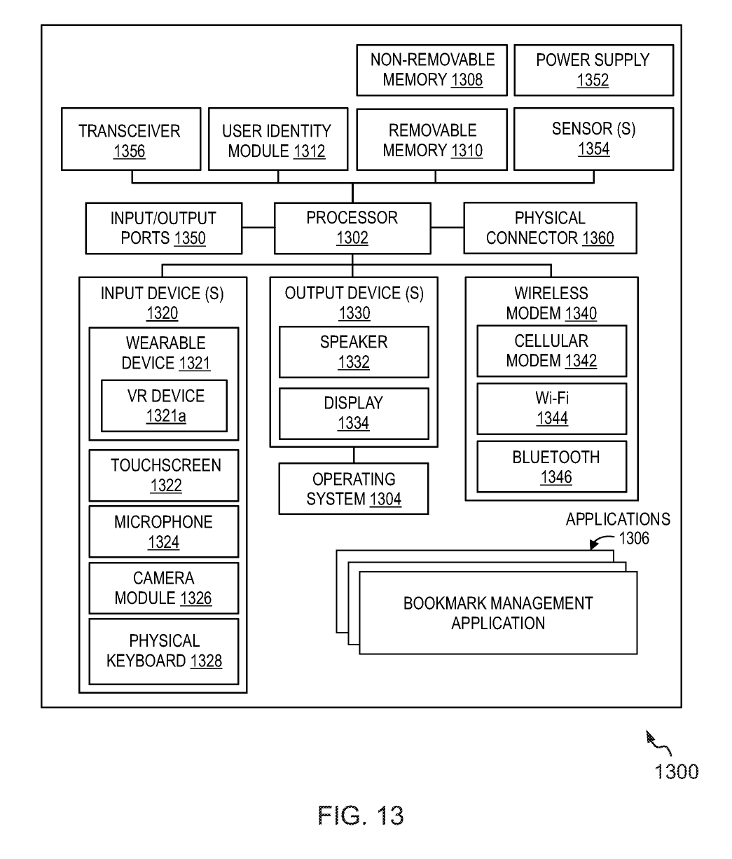

FIG. 13 shows a computing device 1300 capable of implementing the various embodiments of the present invention. In an embodiment, the various operations performed by the system 114 may be implemented using an application in a computing device, such as the computing device 1300. For example, the computing device 1300 may correspond to an electronic device (such as the desktop computer 108) corresponding to the user 102. The computing device 1300 is depicted to include one or more applications 1306, including an application for bookmark management, which serves as an instance of the application downloaded from the system 114 and capable of communicating through API calls with the system 114 to manage bookmarks.

It should be understood that the computing device 1300 as illustrated and hereinafter described is merely illustrative of one type of device and should not be taken to limit the scope of the embodiments. As such, it should be appreciated that at least some of the components described below in connection with that the computing device 1300 may be optional and thus in an example embodiment may include more, less or different components than those described in connection with the example embodiment of the FIG. 13. As such, among other examples, that the computing device 1300 could be any of a mobile electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated computing device 1300 includes a controller or a processor 1302 (e.g., a signal processor, microprocessor, ASIC, or other control and processing logic circuitry) for performing such tasks as signal coding, data processing, image processing, input/output processing, power control, and/or other functions. An operating system 1304 controls the allocation and usage of the components of the computing device 1300 and support for one or more applications programs (see, applications 1306), such as bookmark management application, that implements one or more of the innovative features described herein. In addition to bookmark management application, the applications 1306 may include common mobile computing applications (e.g., telephony applications, email applications, calendars, contact managers, web browsers, messaging applications) or any other computing application. The bookmark management application, in at least one example embodiment, may be configured to provide the logics to manage the bookmarks, as explained with reference to FIGS. 1 to 12.

The illustrated computing device 1300 includes one or more memory components, for example, a non-removable memory 1308 and/or removable memory 1310. The non-removable memory 1308 and/or removable memory 1310 may be collectively known as database in an embodiment. The non-removable memory 1308 can include RAM, ROM, flash memory, a hard disk, or other well-known memory storage technologies. The removable memory 1310 can include flash memory, smart cards, or a Subscriber Identity Module (SIM). The one or more memory components can be used for storing data and/or code for running the operating system 1304 and the applications 1306.

The computing device 1300 can support one or more input devices 1320 and one or more output devices 1330. Examples of the input devices 1320 may include, but are not limited to, a wearable device 1321 further including a VR (Virtual Reality) device 1321a (such that eye movements of the user 102 can trigger actions within the bookmark management application), a touch screen/a display screen 1322 (e.g., capable of capturing finger tap inputs, finger gesture inputs, multi-finger tap inputs, multi-finger gesture inputs, or keystroke inputs from a virtual keyboard or keypad), a microphone 1324 (e.g., capable of capturing voice input), a camera module 1326 (e.g., capable of capturing still picture images and/or video images) and a physical keyboard 1328. Examples of the output devices 1330 may include, but are not limited to a speaker 1332 and a display 1334. Other possible output devices can include piezoelectric or other haptic output devices. Some devices can serve more than one input/output function. For example, the touch screen 1322 and the display 1334 can be combined into a single input/output device.

A wireless modem 1340 can be coupled to one or more antennas (not shown in the FIG. 13) and can support two-way communications between the processor 1302 and external devices, as is well understood in the art. The wireless modem 1340 is shown generically and can include, for example, a cellular modem 1342 for communicating at long range with the mobile communication network, a Wi-Fi compatible modem 1344 for communicating at short range with an external Bluetooth-equipped device or a local wireless data network or router, and/or a Bluetooth-compatible modem 1346. The wireless modem 1340 is typically configured for communication with one or more cellular networks, such as a GSM network for data and voice communications within a single cellular network, between cellular networks, or between the computing device 1300 and a public switched telephone network (PSTN).

The computing device 1300 can further include one or more input/output ports 1350, a power supply 1352, one or more sensors 1354 for example, an accelerometer, a gyroscope, a compass, or an infrared proximity sensor for detecting the orientation or motion of the computing device 1300, a transceiver 1356 (for wirelessly transmitting analog or digital signals) and/or a physical connector 1360, which can be a USB port, IEEE 1294 (FireWire) port, and/or RS-232 port. The illustrated components are not required or all-inclusive, as any of the components shown can be deleted and other components can be added.

Various embodiments of the present technology provide a method and system that enable users to save and retrieve one or more web pages in a time-saving manner. The present invention introduces a set of new capabilities that are leveraged in the context of organizing information of bookmarking the web page content and web research. The various features of the present invention simplify the bookmarking process that leads to easier retrieval and more valuable usage of the bookmarks. The association of the tags with the web pages allows identifying and filtering of the desired web pages from a pool of the saved web pages efficiently. Further, storing the bookmarked web pages as per collection type also eases the filtering process. The comparison view of one or more individually selected bookmarked web pages and enabling the users to change corresponding attribute-value allows them to change priority of the displayed bookmarks in real time. The provision to enable the communication between the users and the web owners of the web site for the bookmarked web pages allows the web owner to better understand needs and interests of the users visiting their websites and accordingly transform the prospective users into regular visitors/customers. The website owner can suggest contextual information such as physical street address of the user which can be presented to the user in the bookmarking process. Such process enables the user to not only have the text value of the address, but the context that the text value is an address which the user can later see on a map to get directions to the address.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the system 114 and its various components, such as the processor 1206, the database 1202, the communication interface 1204 and the memory 1208 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations (for example, operations explained herein with reference to FIG. 10 and FIG. 11). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A computer-implemented method, comprising:
receiving, by a processor, at least one request generated from a User Interface (UI) of a user device to bookmark at least one web page;
determining, by the processor, a set of relevant tags to be associated with the at least one web page, the set of relevant tags determined, based at least in part, on previously bookmarked one or more web pages;
facilitating, by the processor, the set of relevant tags on the UI;
receiving, by the processor, a set of user inputted tags from the UI to bookmark the at least one web page, the set of user inputted tags being at least one of:
the set of relevant tags; and
a set of user custom tags provided by a user of the user device, the set of user custom tags being different from the set of relevant tags; and
storing, by the processor, the set of user inputted tags corresponding to the at least one web page.

2. The method of claim 1, wherein each of the set of user inputted tags comprises:
a label, or
a label paired with a value associated with the label.

3. The method of claim 2, wherein the value is of at least one data type of a plurality of data types, the plurality of data types comprising a string, an integer, a decimal number and a binary number.

4. The method of claim 2, further comprising:
receiving at least one retrieval request from the user to retrieve at least one bookmarked web page;
facilitating a set of user inputted tags to be filtered by the user on the UI based on the at least one retrieval request, the set of user inputted tags associated with the previously bookmarked one or more web pages;
receiving at least one filtered user inputted tag from the facilitated set of user inputted tags from the user; and
retrieving the at least one bookmarked web page corresponding to the at least one filtered user inputted tag.

5. The method of claim 4, further comprising facilitating the set of user inputted tags to be filtered based on a set of values,
wherein retrieving the at least one bookmarked web page comprises interpreting, by the processor, a data type of the set of values.

6. The method of claim 2, further comprising:
receiving at least one comparison request from the user to compare the previously bookmarked one or more web pages;
determining a set of user inputted tags to be displayed on a comparison view on the UI based, in part, on being tagged on any one web page of a designated collection, the designated collection configured to store one or more relevant web pages; and
displaying the previously bookmarked one or more web pages with the determined set of user inputted tags on the comparison view.

7. The method of claim 6, wherein receiving the at least one comparison request comprises receiving a set of tag filters, the set of tag filters being a combination of standard tags and attribute tags, each of the attribute tags containing a label and a value or a range of values.

8. The method of claim 7, wherein the comparison view is at least one a table view and a spreadsheet view.

9. The method of claim 8, further comprising facilitating the user to edit the comparison view.

10. The method of claim 9, wherein editing the comparison view comprises performing at least one of:
editing a value corresponding to a label in the comparison view;
adding a tag into the comparison view;
reordering a display of tags in the comparison view; and
hiding one or more displayed tags from the comparison view.

11. The method of claim 6, further comprising:
facilitating individual selection of the previously bookmarked one or more web pages by the user to be included on the comparison view;
facilitating downloading of data displayed on the comparison view; and
facilitating sharing of the data displayed on the comparison view with at least one third party.

12. The method of claim 1, further comprising:
facilitating at least one communication channel between the user device and a representative device of a web page, the web page bookmarked by the user device.

13. The method of claim 12, further comprising:
receiving a request from the representative device of the web page to verify ownership of the web page; and
facilitating an identification mark for the at least one communication channel in the web page bookmarked by the user device.

14. The method of claim 13, further comprising sending a notification to the representative device in response to bookmarking of the web page by the user device.

15. The method of claim 1, wherein the set of relevant tags further comprise any of a set of sub-levelled relevant tags, a set of meta-tags extracted from content of the at least one web page to be bookmarked, a set of smart tags configured to display the at least one bookmarked web page on corresponding at least one widget, a set of attribute tags, a set of previously entered user custom tags and a set of context based attribute-value pairs.

16. The method of claim 1, wherein determining the set of relevant tags to be associated with the at least one web page further comprises:
generating the set of relevant tags based on other user's publically designated bookmarked web pages and a collection type of default collection where one or more web pages are stored.

17. The method of claim 2, further comprising:
facilitating modification of at least one user inputted tag from the set of user inputted tags corresponding to the at least one web page by the user; and
updating the modified at least one user inputted tag corresponding to the at least one web page.

18. A system, comprising:
at least one processor;
a communication interface, controlled by the at least one processor, to communicate with a user device; and
a memory having stored therein machine executable instructions, that when executed by the at least one processor, cause the system to:
receive at least one request generated from a User Interface (UI) of the user device to bookmark at least one web page;
determine a set of relevant tags to be associated with the at least one web page, the set of relevant tags determined, based at least in part, on previously bookmarked one or more web pages;
facilitate the set of relevant tags on the UI;
receive a set of user inputted tags from the UI to bookmark the at least one web page, the set of user inputted tags being at least one of:
the set of relevant tags; and
a set of user custom tags provided by a user of the user device, the set of user custom tags being different from the set of relevant tags; and
store the set of user inputted tags corresponding to the at least one web page in a database of the system.

19. The system of claim 18, wherein each of the set of user inputted tags comprises:
a label, or
a label paired with a value associated with the label.

20. The system of claim 19, wherein the system is further caused to:
receive at least one retrieval request from the user to retrieve at least one bookmarked web page;
facilitate a set of user inputted tags to be filtered by the user on the UI based on the at least one retrieval request, the set of user inputted tags associated with the previously bookmarked one or more web pages;
receive at least one filtered user inputted tag from the facilitated set of user inputted tags from the user; and
retrieve the at least one bookmarked web page corresponding to the at least one filtered user inputted tag.

21. The system of claim 19, wherein the system is further caused to:
receive at least one comparison request from the user to compare the previously bookmarked one or more web pages;
determine a set of user inputted tags to be displayed on a comparison view on the UI based, in part, on being tagged on any one web page of a designated collection, the designated collection configured to store one or more relevant web pages; and
display the previously bookmarked one or more web pages with the determined set of user inputted tags on the comparison view.

22. The system of claim 21, wherein the comparison view is at least one of a table view and a spreadsheet view.

23. The system of claim 22, wherein the system is further caused to:
facilitate the user to edit the comparison view, wherein editing the comparison view comprises at least one of:
editing a value corresponding to a label in the comparison view;
adding a tag into the comparison view;
reordering a display of tags in the comparison view; and
hiding one or more displayed tags from the comparison view

24. The system of claim 21, wherein the system is further caused to:
facilitate individual selection of the previously bookmarked one or more web pages by the user to be included on the comparison view;
facilitate downloading of data displayed on the comparison view; and
facilitate sharing of the data displayed on the comparison view with at least one third party.

25. The system of claim 18, wherein the system is further caused to:
facilitate at least one communication channel between the user device and a representative device of a web page, the web page bookmarked by the user device.

26. The system of claim 25, wherein the system is further caused to:
receive a request from the representative device of the web page to verify ownership of the web page; and
facilitate an identification mark for the at least one communication channel in the web page bookmarked by the user device.

27. The system of claim 26, wherein the system is further caused to:
send a notification to the representative device in response to bookmarking of the web page by the user device.

28. The system of claim 18, wherein the set of relevant tags further comprise any of a set of sub-levelled relevant tags, a set of meta-tags extracted from content of the at least one web page to be bookmarked, a set of smart tags configured to display the at least one bookmarked web page on corresponding at least one widget, a set of attribute tags, a set of previously entered user custom tags and a set of context based attribute-value pairs.

29. The system of claim 18, wherein for determining the set of relevant tags to be associated with the at least one web page, the system is further caused to:
generate the set of relevant tags based on other user's publically designated bookmarked web pages and a collection type of default collection where one or more web pages are stored.

30. The system of claim 19, wherein the system is further caused to:
facilitate modification of at least one user inputted tag from the set of user inputted tags corresponding to the at least one web page by the user; and
update the modified at least one user inputted tag corresponding to the at least one web page.

31. A method, comprising:
receiving, by a processor, a request generated from a User Interface (UI) of a user device to bookmark a web page of a website;
facilitating, by the processor, a set of relevant tags on the UI, the set of relevant tags determined by the processor in response to the request;
receiving, by the processor, a set of user inputted tags from the UI to bookmark the web page, the set of user inputted tags being at least one of:
the set of relevant tags; and
a set of user custom tags provided by a user of the user device; and
storing, by the processor, the set of user inputted tags corresponding to the web page;
receiving a communication request from the UI to communicate with a website representative device associated with the website; and
facilitating a communication between the user device and the website representative device based on the communication request.

32. The method of claim 31, wherein receiving a communication request from the UI comprises facilitating an identification mark on the web page for user selection for initiating the communication with the website representative device associated with the web page of the website.
